(19) United States
(12) Patent Application Publication
(10) Pub. No.: US 2010/0131692 A1
(43) Pub. Date: May 27, 2010

(54) BUS BRIDGE APPARATUS AND BUS BRIDGE SYSTEM

(75) Inventors: Masanori Nishizawa, Fuchu-shi (JP); Ken Okuyama, Ichikawa-shi (JP)

Correspondence Address: SPRINKLE IP LAW GROUP, 1301 W. 25TH STREET, SUITE 408, AUSTIN, TX, 78705, US

(73) Assignee: KABUSHIKI KAISHA TOSHIBA, Tokyo (JP)

(21) Appl. No.: 12/623,804

(22) Filed: Nov. 23, 2009

(30) Foreign Application Priority Data
Nov. 26, 2008 (JP) JP-2008-301295

(51) Int. Cl. G06F 13/36

(52) U.S. Cl. 710/310

(57) ABSTRACT

A bus bridge is connected between a general-purpose first bus and a second bus on which an interruption signal is transmitted using a packet. The bus bridge includes a plurality of reception buffers and a control section. The control section controllably switches the order of read of the read responses and the requests based on the order of reception of the read responses and the requests after recognizing reception of an interruption assert signal packet transferred by the second bus and before recognizing reception of an interruption de-assert signal packet transferred by the second bus.

### CROSS-REFERENCE TO RELATED APPLICATIONS

This application is based upon and claims the benefit of priority from prior Japanese Patent Application No. 2008-301295, filed Nov. 26, 2008, the entire contents of which are incorporated herein by reference.

### BACKGROUND OF THE INVENTION

1. Field of the Invention

The present invention relates to a bus bridge apparatus and a bus bridge system, and in particular, to control of read of read responses and requests from a reception buffer in a bus bridge apparatus connected between a general-purpose bus and a bus requiring the reception buffer and transmitting a notification of interruption using a packet. The present invention is used in a system utilizing, for example, PCI Express.

2. Description of the Related Art

In a system utilizing, for example, PCI Express, a bus bridge is connected between a general-purpose first bus connected to a first device and a second bus connected to a second device. The bus bridge includes two reception buffers configured to receive read responses and write/read requests, respectively, transferred via the second bus. In this case, the second bus requires the reception buffers and transmits a notification of interruption using a packet. The second device may involve a plurality of interruption factors, for example, a plurality of direct memory accesses (DMA).

In a bus bridge of this kind, the reception buffer for read responses and the reception buffer for write/read requests are independently operated. Thus, the process of delivering a read response to the first bus and the process of delivering a write/read request to the first bus can be achieved without affecting each other. However, if a plurality of DMA controllers (hereinafter referred to as DMACs) operate simultaneously in the second device, the following problems may occur.

That is, for the interruption factor in response to an interruption signal assert packet transmitted by the second device and notifying the first device of DMA completion, consistency may fail to be maintained between an reception of a response for an interruption status read performed by the first device to check with the second device and an interruption completion status issued by the second device. This will be specifically described below.

It is assumed that immediately before a request for an interruption status register read is issued to the second device by the first device, a plurality of DMACs in the second device complete operation and the final DMA transfer is performed. In this case, the bus bridge stores the final DMA write request in the reception buffer for write read requests. A response to the interruption status read is stored in the reception buffer for read responses.

When a target section of the first device to which the write/read request is input is busy, preventing the bus bridge from issuing the final DMA write request to the first device, the response to the interruption status read may be transmitted to the first device before the final DMA write packet is transmitted. In this case, the first device determines that a plurality of DMACs have completed operation based on the information in the response to the interruption status read. However, the final DMA write packet remains in the reception buffer for request receptions which is located in the bus bridge. Thus, the first device cannot maintain consistency between the recognition of interruption completion and the actual data transfer.

Jpn. Pat. Appln. KOKAI Publication No. 11-338816 discloses a technique to allow a bus bridge containing a bus arbiter to perform efficient bus arbitration to enable high-speed data transfers.

### BRIEF SUMMARY OF THE INVENTION

According to a first aspect of the present invention, there is provided a bus bridge apparatus connected between a general-purpose first bus and a second bus on which data containing an interruption signal is transmitted using a packet, the apparatus comprising:

a plurality of reception buffers configured to receive read responses and requests transferred via the second bus; and

a control section configured to recognize reception of the read requests and requests transferred via the second bus and to switch a function to independently control an order of read of the read requests and requests received by the plurality of reception buffers and a function to control the read in order of reception of the read responses and the requests, the control section controllably switches the order of read of the read responses and the requests based on the order of reception of the read responses and the requests after recognizing reception of an interruption assert signal packet transferred by the second bus and before recognizing reception of an interruption de-assert signal packet transferred by the second bus.

According to a second aspect of the present invention, there is provided a bus bridge system comprising:

a general-purpose first bus;

a first device connected to the first bus;

a second bus on which data containing an interruption signal is transferred using a packet;

a second device connected to the second bus and including a plurality of direct memory access controllers; and

a bus bridge connected between the first bus and the second bus and including a plurality of reception buffers, the bus bridge recognizing reception of read responses and requests transferred via the second bus, and after recognizing reception of an interruption assert signal packet and before recognizing reception of an interruption de-assert signal packet, outputting the read requests and requests transferred via the second bus and received by the plurality of reception buffers in order of the reception of the read responses and the requests.

### BRIEF DESCRIPTION OF THE SEVERAL VIEWS OF THE DRAWING

FIG. 1 is a block diagram showing the configuration of a bus bridge and a bus bridge system according to an embodiment of the present invention;

FIG. 2 is a timing diagram showing the relationship between a packet-based interruption and a level-based interruption in a second bus in FIG. 1;

FIG. 3 is a block diagram illustrating an example of the operation of the bus bridge and bus bridge system in FIG. 1;

FIG. 4 is a block diagram illustrating an example of an operation performed upon reception of an assert INT message in the bus bridge in FIG. 1; and

FIG. 5 is a block diagram illustrating an example of an operation performed upon reception of a de-assert INT message in the bus bridge in FIG. 1.

### DETAILED DESCRIPTION OF THE INVENTION

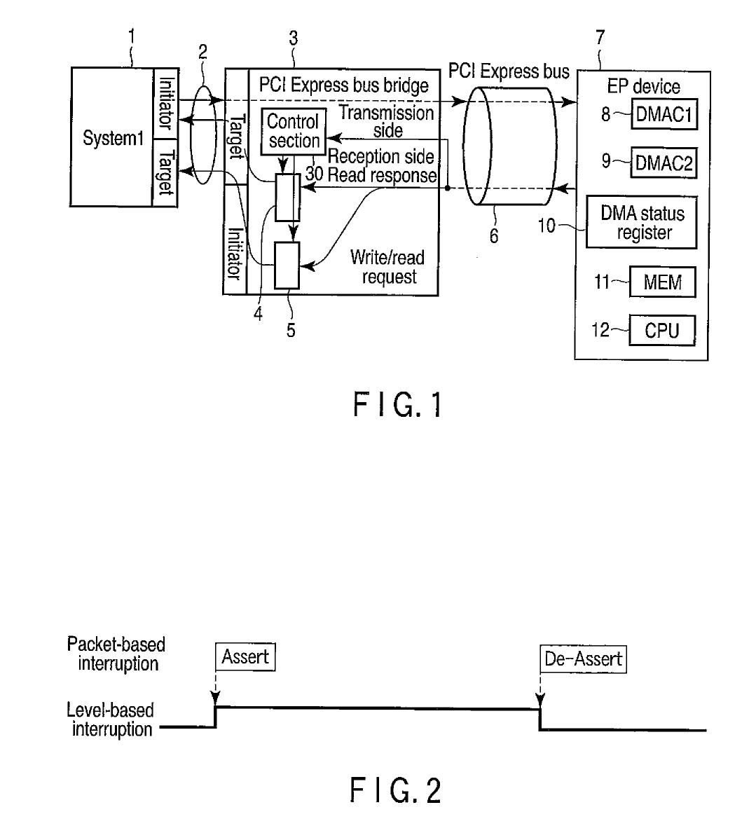

The present invention will be described below based on an embodiment with reference to the drawings. FIG. 1 is a block diagram showing the configuration of a system utilizing, for example, PCI Express, as an embodiment of a bus bridge and a bus bridge system according to the present invention. Reference numerals 1 and 2 denote a first device (System 1) and a first bus, respectively. Reference numeral 3 denotes a bus bridge. Reference numerals 6 and 7 denote a second bus and a second device (System 2), respectively. In the present example, the second bus 6 is a PCI Express bus. The bus bridge 3 is a PCI Express bus bridge. The second device 7 is an end point device (EP device).

The first bus 2 is a general-purpose bus such as AMBA or OCP. The first bus 2 is connected between an initiator section of the first device 1 and a target section of the bus bridge 3 and between an initiator section of the bus bridge 3 and a target section of the first device 1.

The second bus 6 requires reception buffers and flow control in which a notification of interruption is transmitted using a packet (assert INT message/de-assert INT message). FIG. 2 shows the relationship between an interruption based on a packet transferred on the second bus 6 and an interruption based on a signal level. Here, the assert period of an interruption signal based on the signal level is equivalent to the period from reception of an interruption signal assert packet indicating that an interruption signal is asserted until reception of an interruption signal de-assert packet indicating that an interruption signal is de-asserted.

The second device 7 involves a plurality of interruption factors and includes a plurality of DMACs and an interruption status register (in the present example, a DMA status register 10), a memory (MEM) 11, and CPU 12. In the present example, a first DMAC (DMAC1) 8 and a second DMAC (DMAC2) 9 are shown as the plurality of DMACs.

The bus bridge 3 includes a reception buffer 4 for read responses which receives a response to a read request issued by the first device 1 and a reception buffer 5 for requests which receives a write/read request issued by the second device 7.

In the present embodiment, the bus bridge 3 further includes a control section 30. The control section 30 controllably switches the function of recognizing reception of read responses and requests transferred via the second bus 6 and independently controlling the order of reads from the reception buffer 4 and the reception buffer 5 and the function of controlling the reads in order of the reception of the read responses and the requests. That is, the control section 30 recognizes the reception of read responses and requests and controllably switches the reads from the reception buffer 4 and 5 as described below in (1) and (2).

(1) After reception of an interruption signal assert packet and before reception of an interruption signal de-assert packet, a response to a read request issued to the second device 7 by the first device 1 and requests issued by the second device 7 are controllably read in the order that the bus bridge 3 receives the response and the request.

(2) During the other periods, read control is independently performed on the response to the read request issued to the second device 7 by the first device 1 and on the request issued by the second device 7.

As described above, according to the present embodiment, the control function of the control section 30 provided in the bus bridge 3 enables consistency to be maintained between an interruption completion status established upon completion of a plurality of DMA write transfers provided by the second device 7 and a response to an interruption status read, with a decrease in the efficiency of the first bus 2 prevented.

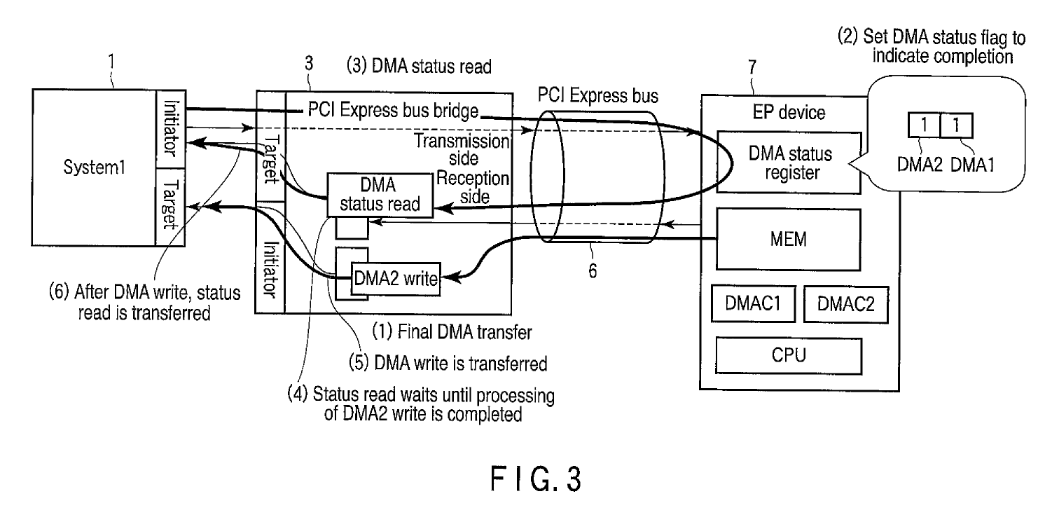

An example of the operation of the whole bus bridge system in FIG. 1 will be described below in detail. FIG. 3 is a block diagram illustrating an example of the operation of the bus bridge system in FIG. 1.

The bus bridge 3 independently controls the processing of responses to read requests issued to the second device 7 by the first device 1 (control of reads from the reception buffer 4) and the processing of requests issued by the second device 7 (control of reads from the reception buffer 5) until the bus bridge 3 receives an interruption signal assert packet issued by the EP device. During the independent processing, the two buffers 4 and 5 are independently operated. Thus, even if the first bus 2 is in a busy state with respect to one of the reception buffers, the other reception buffer is prevented from being affected. Consequently, the read responses and the requests can be transmitted to the first device 1 without being affected.

Now, processing executed when DMA writes are being simultaneously operated by DMAC1 and DMAC2 in the EP device 7 will be described in brief. When the DMA write performed by DMAC1 in the EP device 7 is completed, the EP device 7 issues an interruption signal assert packet to the first device 1. At this time, a DMAC1 completion status corresponding to an interruption factor is set in the DMA status register 10 in the EP device 7.

Furthermore, at this time, after recognizing the interruption signal assert packet, the bus bridge 3 switches the method for controlling the read of read requests and requests from the reception buffers 4 and 5 so that the read responses and the requests are processed in order of the reception of the read responses and the requests (sequential processing). Then, the bus bridge 3 notifies the first device 1 that the interruption signal assert packet has been received. During the sequential processing, packets input via the PCI Express bus 6 are output to the first bus 2 in order of the input. Apparently, only one of the two reception buffers 4 and 5 is present.

To check the interruption factor, the first device 1 reads an interruption status (reads the status from the DMA status register 10 in the EP device 7). At this time, if the DMA write performed by DMAC2 in the EP device 7 is completed (the final DMA transfer is performed) immediately before the request for the interruption status read is issued to the EP device 7 by the first device 1, the completion allows a DMAC1 completion status bit and a DMAC2 completion status bit to be set in the DMA status register 10 in the EP device 7 as shown in (2) in FIG. 3.

Thereafter, when the interruption status read requested of the EP device 7 by the first device 1 is performed, response data with the set 2 bits is transmitted to the first device 1 by the EP device 7 as shown in (3) in FIG. 3.

At this time, in the bus bridge 3, the final write request from DMAC2 is stored in the reception buffer 5 for write/read requests. The response to the interruption status read is stored in the reception buffer 4 for read responses.

In this case, as shown in (4) in FIG. 3, the response to the interruption status read remains in the reception buffer 4 until the final write request from DMAC2 is transferred to the first device 1.

As shown in (5) in FIG. 3, the transfer of the final write request for DMAC2 from the bus bridge 3 to the first device 1 is finished. Thereafter, as shown in (6) in FIG. 3, the transfer of the response to the interruption status read from the bus bridge 3 to the first device 1 is finished. Thereafter, the first device 1 issues, to the EP device 7, a request for clearing of the DMAC completion status in the interruption status of the EP device 7.

When the DMAC completion status in the interruption status is cleared, the EP device 7 transmits an interruption signal de-assert packet to the first device 1 in order to de-assert the interruption signal asserted by the first device 1.

Upon receiving the interruption signal de-assert packet from the EP device 7, the bus bridge 3 switches the processing of read responses and requests from the processing in order of reception to the independent processing.

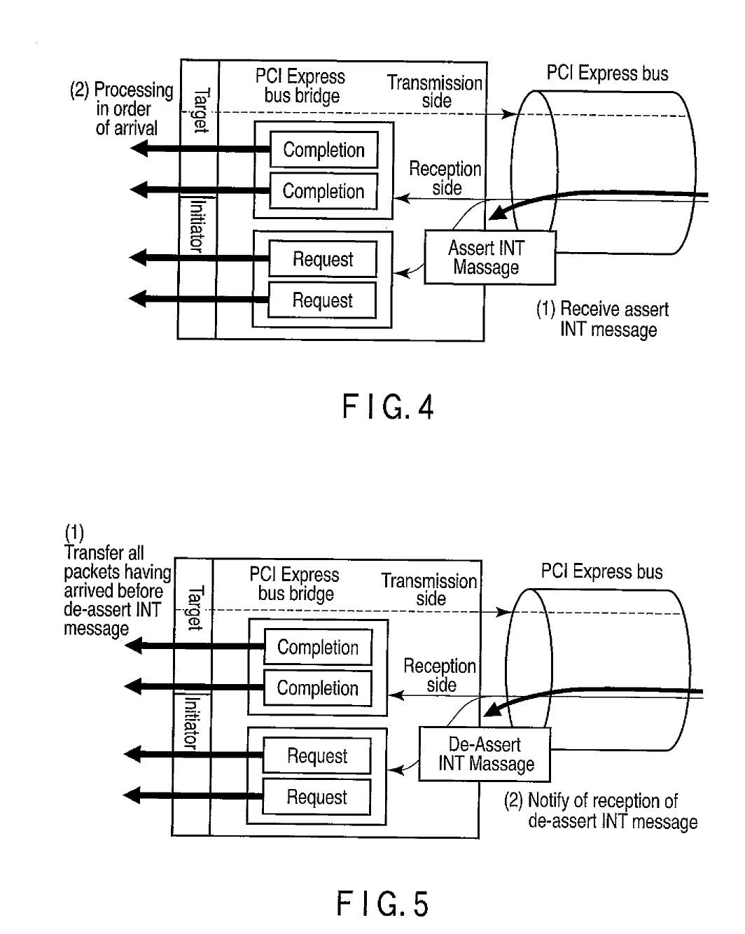

Now, the switching control for the operation mode of the reception buffers 4 and 5 will be described with reference to FIGS. 4 and 5. FIG. 4 shows an example of an operation performed by the bus bridge 3 in FIG. 1 upon reception of an interruption signal assert packet (assert INT message). Upon receiving and recognizing the assert INT message as shown in (1) in FIG. 4, the bus bridge 3 switches the method for control of read of read responses (completion) and requests from the reception buffers 4 and 5, to the processing in which the read responses and the requests are transmitted to the first system 1 in the order of reception of the read responses and requests from the PCI Express bus 6. That is, upon recognizing the assert INT message, the bus bridge 3 changes the order of read control for completion messages and requests to the order of arrival. Thus, subsequently received completion messages and requests are processed (read) in order of the reception of the completion messages and requests. The bus bridge 3 notifies the first system 1 of the reception of the assert INT message after transmitting all of the previously received completion messages and requests to the first system 1.

FIG. 5 shows an example of an operation performed by the bus bridge 3 in FIG. 1 upon reception of an interruption signal de-assert packet (de-assert INT message). Upon recognizing the de-assert INT message, the bus bridge 3 is executing processing in order of reception of requests and completion messages from the PCI Express bus 6. The bus bridge 3 notifies the first system 1 of the reception of the de-assert INT message after transmitting all of the previously received requests and completion messages to the first system 1. That is, as shown in (1) in FIG. 5, the bus bridge 3 transmits all the packets having arrived before the de-assert INT message as shown in (1) in FIG. 5, before transmitting the de-assert INT message to the first system 1 as shown in (2) in FIG. 5. Thereafter, the read control for completion messages and requests returns to the independent processing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A bus bridge apparatus connected between a general-purpose first bus and a second bus on which data containing an interruption signal is transmitted using a packet, the apparatus comprising:
a plurality of reception buffers configured to receive read responses and requests transferred via the second bus; and
a control section configured to recognize reception of the read requests and requests transferred via the second bus and to switch a function to independently control an order of read of the read requests and requests received by the plurality of reception buffers and a function to control the read in order of reception of the read responses and the requests, the control section controllably switches the order of read of the read responses and the requests based on the order of reception of the read responses and the requests after recognizing reception of an interruption assert signal packet transferred by the second bus and before recognizing reception of an interruption de-assert signal packet transferred by the second bus.

2. The bus bridge apparatus according to claim 1, wherein the plurality of reception buffers includes a first reception buffer configured to receive read responses to read requests and a second reception buffer configured to receive a write/read request.

3. The bus bridge apparatus according to claim 1, wherein the second bus performs flow control.

4. The bus bridge apparatus according to claim 1, wherein the second bus is a PCI Express bus.

5. The bus bridge apparatus according to claim 1, wherein the control section recognizes reception of the interruption signal assert packet and then controllably reads the read requests and requests preciously received by the plurality of reception buffers.

6. The bus bridge apparatus according to claim 1, wherein the control section recognizes reception of the interruption signal de-assert packet and then controllably independently reads the read requests and requests transferred via the second bus and received by the plurality of reception buffers.

7. A bus bridge system comprising:
a general-purpose first bus;
a first device connected to the first bus;
a second bus on which data containing an interruption signal is transferred using a packet;
a second device connected to the second bus and including a plurality of direct memory access controllers; and
a bus bridge connected between the first bus and the second bus and including a plurality of reception buffers, the bus bridge recognizing reception of read responses and requests transferred via the second bus, and after recognizing reception of an interruption assert signal packet and before recognizing reception of an interruption de-assert signal packet, outputting the read requests and requests transferred via the second bus and received by the plurality of reception buffers in order of the reception of the read responses and the requests.

8. The bus bridge system according to claim 7, wherein the plurality of reception buffers includes a first reception buffer configured to receive read responses to read requests and a second reception buffer configured to receive a write/read request.

9. The bus bridge system according to claim 7, wherein the second bus performs flow control.

10. The bus bridge system according to claim 7, wherein the second bus is a PCI Express bus.

11. The bus bridge system according to claim 7, wherein the bus bridge recognizes reception of the interruption signal assert packet, and then the reception buffers read the read requests and requests preciously received by the plurality of reception buffers, in order of the reception of the read responses and the requests and output the read responses and the requests to the first bus.

12. The bus bridge system according to claim 7, wherein the bus bridge recognizes reception of the interruption signal de-assert packet and then the plurality of reception buffers independently read the read requests and requests preciously received by the plurality of reception buffers and output the read responses and the requests to the first bus.
